(19) United States
(12) Patent Application Publication
(10) Pub. No.: US 2005/0209392 A1
(43) Pub. Date: Sep. 22, 2005

(54) Polymer binders for flexible and transparent conductive coatings containing carbon nanotubes

(76) Inventors: Jiazhong Luo, Acton, MA (US); Paul J. Glatkowski, Littleton, MA (US); Philip Wallis, Barrington, RI (US)

Correspondence Address: MORRISON & FOERSTER LLP, 1650 TYSONS BOULEVARD, SUITE 300, MCLEAN, VA, 22102, US

(21) Appl. No.: 11/014,233

(22) Filed: Dec. 17, 2004

Related U.S. Application Data
(60) Provisional application No. 60/529,735, filed on Dec. 17, 2003.
(60) Provisional application No. 60/549,159, filed on Mar. 3, 2004.

(51) Int. Cl. C08K 3/04

(52) U.S. Cl. 524/496

(57) ABSTRACT

This invention relates to flexible, transparent and conductive coatings and films formed using single wall carbon nanotubes and polymer binders. Preferably, coatings and films are formed from carbon nanotubes (CNT) applied to transparent substrates forming one or multiple conductive layers at nanometer level of thickness. Polymer binders are applied to the CNT network coating having an open structure to provide protection through infiltration. This provides for the enhancement of properties such as moisture resistance, thermal resistance, abrasion resistance and interfacial adhesion. Polymers may be thermoplastics or thermosets, or any combination of both. Polymers may also be insulative or inherently electrical conductive, or any combination of both. Polymers may comprise single or multiple layers as a basecoat underneath a CNT coating, or a topcoat above a CNT coating, or combination of the basecoat and the topcoat forming a sandwich structure. Binder coating thickness can be adjusted by changing binder concentration, coating speed and/or other process conditions. Resulting films and articles can be used as transparent conductors for flat panel display, touch screen and other electronic devices.

### REFERENCE TO RELATED APPLICATIONS

This patent application claims priority to U.S. Provisional Application No. 60/529,735 entitled “Polymer Binders for Flexible and Transparent Conductive Coatrings having Carbon Nanotubes, and Corresponding Construction Structures, Processes and Articles” filed Dec. 17, 2003, and U.S. Provisional Application No. 60/549,159 entitled “Transparent Conductive Coatings having High and Stable Performance Including Moisture, Heat, Abrasion and Bending Resistance” filed Mar. 3, 2004.

### BACKGROUND

1. Field of the Invention

The present invention is directed to flexible, optionally transparent and conductive coatings and films comprised of carbon nanotubes (CNT) and optionally polymer binders, and to the corresponding fabrication methods, coating layer structures and processes. In particular, the invention is directed to polymer binders applied to provide protection to the CNT layer and enhancement in properties such as moisture resistance, thermal resistance, abrasion resistance and interfacial adhesion.

2. Description of the Background

Transparent and electrically conductive coatings and films are used for versatile applications particularly in flat panel displays, touch screen panel and other electronic applications. These transparent conductors mainly include metal oxides particularly indium-tin oxide (ITO). (See R. G. Gorden, “Criteria for Choosing Transparent Conductors”, MRS Bulletin, Page 52, August/2000). ITO is deposited onto glass and polymer substrates by chemical vapor deposition (CVD), sputtering and other approaches followed by annealing. This offers high electrical conductivity and optical transparency. However, ITO-based coating and film have inferior abrasion resistance and flexibility. The supply of expensive indium is also very limited. Transparent conductive products with easier fabrication and higher performance are in great demand.

Intrinsically conductive polymers such as polyaniline and polythiophene are also used to make flexible transparent conductive coating and films. One significant example is poly(3,4-ethylenedioxythiophene) doped and stabilized with poly(styrenesulfonate) (PEDOT/PSS). (See L. Bert Groenendaal, F. Jonas, D. Freitag, H. Pielartzik, J. R. Reynolds, “Poly(3,4-ethylenedioxythiophene) and Its Derivatives: Past, Present, and Future,” Advanced Materials, Vol. 12, No. 7, pp 481, 2000). However, polymer conductivity and optical transparency are limited. Despite good flexibility, abrasion resistance is also very poor.

Development and application exploration of carbon nanotube have preceded since their discovery in 1991. CNTs include single walled (SWNT), double walled (DWNT) and multi walled carbon nanotubes (MWNT). These forms of CNTs are synthesized by arc-discharge, laser ablation and chemical vapor deposition (CVD), to name a few. (See Carbon Nanotubes Science and Applications; edited by M Meyyappan, CRC Press, 2004). Carbon nanotubes especially SWNT can also have high electrical and thermal conductivity in addition to good mechanical properties.

Carbon nanotubes are generally mixed with polymers (or monomers followed by polymerization) to form nanocomposites. For example, U.S. Pat. No. 6,265,466 relates to electromagnetic shielding composites comprising nanotubes and polymers. Significant research efforts are focusing on preparation of nanocomposites using this approach. The challenges for this approach include difficulty in uniform mixing due to bundles and agglomeration of CNT, and difficulty in achieving very high conductivity due to an insulative nature of polymers.

Transparent conductive coatings and films can be made by incorporating CNT into clear polymers at a desired thickness See generally U.S. Pat. Nos. 5,583,887 and 5,908,585). U.S. patent application Ser. Nos. 10/105,623 and 10/442,176, relate to transparent conductive coatings and films with or without certain patterning formed by using single-wall carbon nanotubes (SWNT) through a two step method (e.g. formation of CNT layer via wet process followed by polymer binder coating).

During development of these SWNT based transparent conductive coatings having high conductivity (e.g., 10-1000 Ω/□), their measured sheet resistance value can fluctuate with changes in time and place.

This type of CNT network coating on the substrates is sensitive to environmental conditions including moisture and heat. Sheet resistance of a dried bare carbon nanotube coating on the substrates could decreases when first exposed to low moisture level, and then significantly increases at different moisture levels after reaching equilibrium. Sheet resistance also increased upon heating especially at high temperatures such as (125-400° C.). The effects of both moisture and temperature are fully or partially reversible.

When flexible substrates such as plastic films are used, the resulting CNT network coating has very good flexibility. However, these coated substrates often do not have extremely high adhesion and abrasion resistance. Typical substrate types include glass.

Currently commercially available transparent conductive coatings and films made from ITO, conducting polymer, and nanocomposites containing nanotubes or other conductive particulates, suffer from at least one common characteristic. All these coating and films are formed as a solid layer to which additional layers of materials can be applied above or below to prove further function or protection from environmental influence. For example, ITO is coated on a flexible transparent polymeric film and over coated with an abrasion resistant polymer such as an acrylic to protect the surface during handling in the factory or by the end user. A disadvantage is that the acrylic top coating also serves to electrically insulate the coated surface, making contact to the conductive ITO difficult or impossible. Since most commercially available transparent conductive coatings and films are solid materials, the addition of other layers typically interferes with this function of surface conductivity. In the case where composites layers are formed comprising a polymer and a conductive constituent, the polymer in the composite can be selected to provide additional functions such as abrasion, humidity, temperature, adhesion and maintain the conductive properties of the layer. This approach is used commercially to form transparent conductive coating with PEDOT and polymeric resins to form a solid layer. The disadvantage to this approach is that in these composite coatings, conductivity is greatly reduced by the presence of polymeric resins which serve to dilute and interrupt the conductive pathways.

### SUMMARY OF THE INVENTION

The present invention overcomes the problems and disadvantages associated with current strategies and designs and provides new tools and methods for providing carbon nanotube coated substrates.

This invention relates to approaches to protect CNT-based and preferably SWNT-based transparent conductive coatings by selectively utilizing polymer binders. When SWNT is first applied onto a substrate, a conductive CNT network coating having open structure (open volume approximately 40-60%) is formed. The polymer binder subsequently applied provides protection by infiltration into the CNT network. Without significant decrease in optical transparency and surface conductivity, the polymer binders provide the resulting products with good stability upon exposure to harsh environments such as moisture and high temperature. In addition, they also have excellent flexibility, adhesion and abrasion resistance. This invention also provides combinations of a CNT coating as primary conductor layer and a conductive polymer as the binder to have transparent and electrically conductive coating and film products. The CNT and polymer binder coatings can be fabricated as layered structures.

One embodiment of the invention is directed to flexible, optionally transparent and conductive coatings and films comprising carbon nanotubes and polymer binders, and the corresponding fabrication methods, coating layer structures, processes and resulting articles. Selective utilization of polymer binders and coating layer structures gives protection of the CNT coating by infiltration into the CNT network from environmental and mechanical conditions (e.g., moisture, heat and abrasion).

Another embodiment of the invention is directed to single walled carbon nanotubes (SWNT) applied to transparent substrates to form one or multiple layers of coating at a nanometer level. Subsequently polymer binders are selectively utilized to protect the CNT conductive layers. The polymers can be either thermoplastics or thermosets, or any combination of both. In particular, the polymers can be hydrophobic for superior moisture resistance, or high molecular weight thermoplastics or cross-linked thermosets for desired abrasion resistance and heat stability, chemically compatible for good adhesion and durability, or inherently electrical conductive for excellent conductivity on the surface, or any combinations of these described.

The polymers can be in a single layer as either a basecoat underneath the nanotube coating, or a topcoat above the nanotube coating, or any combinations of both. They can be in two or more layers with combination of both the basecoat and the topcoat which form “sandwich structure” embedding the nanotube coating in the middle with good interpenetration and interfacial bonding. The CNT conductive coating layers and the binder layers number from single to multiple can be in any suitable combinations. The layer is not limited to conventional meaning of separate independent layer since the polymer binder actually infiltrate into the CNT network coating.

The layer may be further modified by surface modification either chemically or physically, which include deposition of inorganic polymeric materials such as, for example, silane and metal alkoxides. The resulting film and other forms of articles, which also have good flexibility, can be used for flat panel display, touch screen, OLED, MEMS and any other electronic applications.

Other embodiments and advantages of the invention are set forth in part in the description, which follows, and in part, may be obvious from this description, or may be learned from the practice of the invention.

### DESCRIPTION OF THE DRAWINGS

FIG. 1. Different coating layer structures by using carbon nanotubes and binders.

FIG. 2. Moisture Resistance of CNT network coating on glass with or without PVDF binder.

FIG. 3. Effect of PVDF coating times on moisture resistance.

FIG. 4. Improvement of thermal resistance by using PVDF binders.

FIG. 5. TEM image of nanotube coating showing open space between ropes of nanotubes.

FIG. 6. SPM Image of single-walled nanotube coating with 500 Ohms/square resistivity.

FIG. 7. Profilometry of CNT coating thickness on glass substrate.

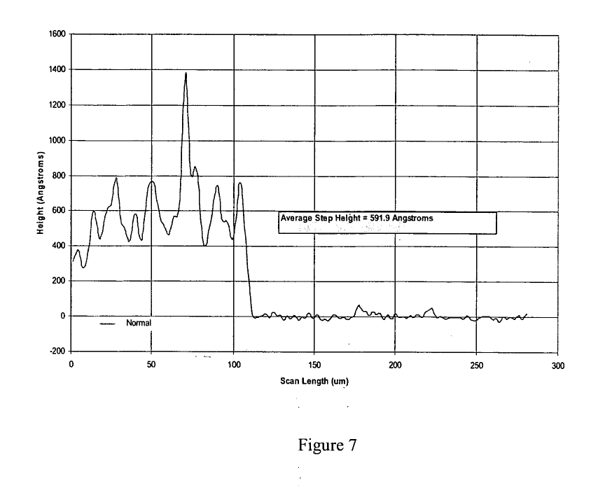

### DESCRIPTION OF INVENTION

As embodied and broadly described herein, the present invention is directed to conductive networks of carbon nanotube coatings and films.

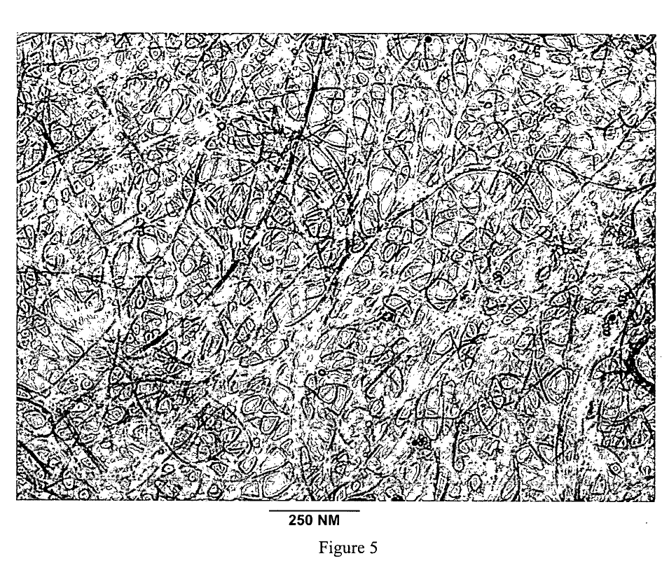

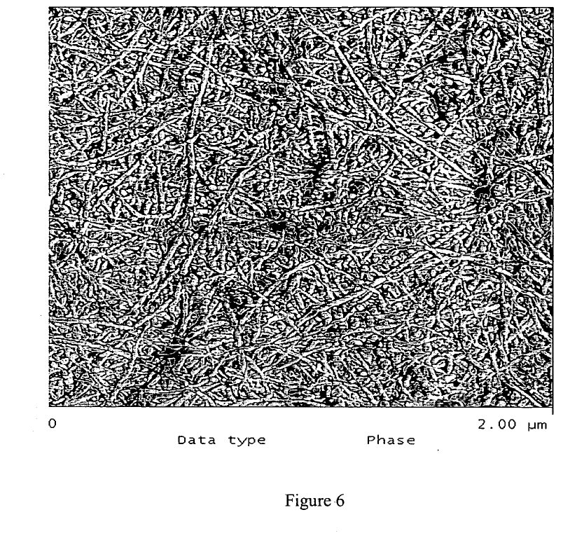

The present invention is directed to conductive networks of CNT optionally formed with binder materials. This approach allows the formation of multilayer coating consisting of several binder materials which do not necessarily cover the conductive CNT layer. The binder coating can be added to the CNT network to partially or completely filling the open spaces between the porous CNT network and can be coated thick enough to completely cover the CNT layer. An additional benefit to this approach is that the top coating/binder not only penetrates the CNT layer but also passes through the CNT layer down to the supporting substrate where binder adheres or reacts to bond the materials and layer together. This resulting composite structure is not possible by conventional means for forming transparent conductive coatings and films. In addition the application of a binder to the CNT network layer can be done such that only a small fraction of the available free space between the CNT network is filled, thereby leaving room for additional resins, reactants, gases to interface/interact with the CNT network (see FIGS. 5 and 6). This approach allows for the same CNT layer to be useful in a variety of applications by selecting binder materials which add additional functional characteristics.

The polymer binder can be applied using very dilute solutions of polymer in solvents. This allow the deposition of very thin (<0.2 micron) coatings on the nanotube network. This is novel since traditionally top coatings applied to plastic or glass substrate are deposited much thicker (1-5 microns) to protect the substrate from abrasion, moisture, thermal degradation, and other environmental damage. In the present invention a very thin binder coating of the same materials provide protection to the transparent conductive layer comprising nanotubes. The coating can be deposited using any traditional coating process such as dip, flow, spin, gravure, roll, or spray. One surprising and unexpected result is that such thin coatings of commercially available coating is effective at providing environmental protect commonly requiring much thicker coatings. The protect provided by the very thin coating on the nanotubes may be attributed to nanoscopic scale of the composite which is formed.

One example of usefulness of the present invention is in touch screen displays wherein the touch sensitive switch is formed from two layers of transparent conductive materials separated by air and spacers. Typically a resistive touch screen employs ITO deposited on glass to form one electrode and also has a second electrode made from ITO deposited on PET polymer film placed on top of the ITO/glass layers. When a finger touches the structure, the two layers contact sending a signal and thereby allowing the position of the finger to be sensed. Frequent use of the ITO layer in this manner renders the layers prone to cracking and failure. In the present invention a binder material can be added to make a more durable coating which is bonded to the polymer or glass substrates to prevent failure. ITO can not modified in this way especially when dispersed in a binder material and coated. The resulting ITO composite would not have the same electrical and optical performance characteristics as that of the solid layer of ITO.

This present invention is also useful as a direct replacement in all applications where ITO is used as a transparent conductive coating or electrode in products, such as in touch screens; LCD, plasma and OLED displays; ESD coatings, EMI shielding coatings; windows and lenses; electrochromic, electroluminescent and field emission displays, heat reflective coatings, energy efficient windows, gas sensors, and photovoltaics.

Binders are a novel idea for carbon nanotubes at least because:

1. SWnT are applied to a substrate and then fixed into position maintaining most of the electrical properties of the applied film.

2. SWnT applied alone often loose contact to other SWnT over time if not glued together. This would cause permanent degradation of the sheet resistance of the film that the SWnT were applied. When applied the SWnT rope together. The binder fixes the position of the SWnT to maintain the electrical properties.

3. The binder protects against environmental forces as any top coating will. The binder allows stabilizing of a self-assembled network of SWnT that, when applied to a substrate, prevents the unraveling of the network.

4. Once the binder has stabilized the network of SWnT on a substrate, a more substantial over coating can be applied to safeguard the SWnT from the environmental.

5. The over coating or binder coating only protects the SWnT only slightly as a protective over coating. Conventional protective over coatings are typically many times thicker than the coatings of this invention.

Testing preformed has show how well the SWnT can be bound together. Maintaining electrical properties is a main goal of the binder. Most topcoats maintain the appearance of the underlying substrate, but not the electrical properties. If the film has an excellent appearance, but does not maintain the electrical properties, the binder does not work.

Selective utilization of polymer binder types and coating layer structures provides protection to SWNT based transparent conductive coating. Transparent and conductive coatings in this invention can be made at least using the following combinations of materials, coating layer structures, fabrication methods and processes. The selection and combinations of these parameters deliver the products to meet the performance challenges including high conductivity, optical transparency, flexibility, abrasion resistance, adhesion, environmental (e.g., moisture, high temperature) resistance and long-term durability.

1. Material Types and Combinations

Carbon nanotubes are applied onto transparent substrates to form one or multiple primary conductive layers. Polymers can be used as binders (and potentially secondary conductors in case of conductive polymers) in a certain coating layer structure to deliver resulting products having good mechanical, thermal or electrical properties.

1.1 Carbon Nanotubes

Highly pure carbon nanotubes and bundles can be used in general. Single-wall or dual-wall carbon nanotubes are preferred for high conductivity. Perfect and pure single walled carbon nanotubes (SWNT) having high content of metallic nanotubes are the most preferable. Average outer diameter of the carbon nanotubes is generally 3.5 nm or less. They are generally made by the method of arc-discharge or laser ablation followed by purification. The purification methods include acid treatment followed by extraction, field flow fractionation (FFF) and any other standard methods.

Purified carbon nanotubes are generally dispersed into the organic solvents such as mixture of water and alcohol. They can be applied onto the substrate, for example, by spraying coating, dipping coating, spinning coating, and other deposition method in wet or dry states.

The coating thickness of the CNT network coating can be in the range of 10-1,000 nm depending on sheet resistance value required. It is preferred in the range of 10-500 nm for sheet resistance range of 10-1,000 Ω/□.

1.2 Transparent Substrates

These transparent substrates can be primarily polymer films and glass substrates. These include (but are not limited to) polyester, polycarbonate, polyolefins, polyurethanes, acrylates, epoxies, fluorocarbon elastomers and plastics, and any other type of polymers. Thermoplastics such as polyethylene tetraphthalate (PET) and polyethylene naphthalate (PEN) are preferred for the products used for display applications. Typical brand names for these products include Melinex (PET manufactured by Dupont-Teijin), Lumirror (PET manufactured by Toray) and Teonex (PEN manufactured by Dupont-Teijin). The transmittance value of the film's at wavelength of 550 nm is generally in the range of 80-95% (transmittance≧90% is the most preferable). The glass substrate include regular and optical display grade of glass such as Corning 1737 and Corning Eagle 2000™. The corresponding transmittance at 550 nm is generally higher than 90% (most preferably ≧91%).

1.3. Polymer Binders

Selective utilization of polymer binders. The polymer binders can be thermoplastics or thermosets, or any combinations of both.

They can be applied by dip coating in the form of dilute solution, chemical deposition in the vapor state, sputtering in solid state, or any other approaches. Dip coating is one of the preferred method in which the polymer solution concentration is generally in the range of 0.01-5% (most preferably in the range of 0.1-1%) to achieve desired coating thickness. The polymer can be dissolved in organic solvents having low boiling point. These solvents can be acetone, toluene, methyl ethyl ketone (MEK), water and other suitable chemicals or mixtures. Solvents can be dried off after coating.

The thermoplastic polymers can be polyesters, polyurethanes, polyolefins, fluoroplastics and fluoroelastomers, thermoplastic elastomers, etc. These fluorine-containing polymers include polyvinylidene fluoride (PVDF), polyvinyl fluoride (PVF), polychlorotrifluoroethylene (PCTFE), polyvinylalkyl vinyl ether, any copolymers or polymer mixtures. Thermosplastics can be directly applied to form coating through drying process.

These thermosetting polymers can be cross-linked polyesters, polyurethanes, acrylates, epoxies, melamines, silicones, organosilicon polymers, fluorosilicones, and any other copolymer or hybrid polymeric materials. The corresponding thermoplastic precursors can be applied onto the substrate followed by drying and cross-linking reaction (i.e. curing). They can be cured through heating, moisture, visible light, UV or irradiation, or combined dual curing mechanisms. They can also be applied and then partially or fully cured in the course of fabrication, and fully cured in the end of processes. The partially cured or “B-staged” prepolymers provide advantages in processing because the CNT conductive layer can be pressed into them.

The polymer binders through UV or irradiation curing can be acrylates polymerized through free-radical mechanism, epoxy cured through cationic polymerization, or other materials using other curing mechanism such as thio-vinly reaction chemistries. The materials without oxygen inhibition are preferred for easy processing in air.

It is preferred that these polymers have the following options and/or combinations:

In one preferred embodiment, these polymers have medium or high hydrophobilicity in chemical nature for high moisture resistance. These regular and fluoro-containing thermoplastics, thermosets and elastomers as described above. One example of regular polymer is polyester solution LCC-4 (available from Flexcon) dissolved in the mixture of acetone and toluene. One example of fluoropolymer is PVDF (Hylar SN manufactured by Solvay) dissolved in N,N-dimethylacetamide or acetone.

In another preferred embodiment, polymers can be thermoplastics having high molecular weight or thermosets having cross-linking structures for high thermal and mechanical durability. The thermosetting polymers are used to bond nanotubes together nanomechanically to improve conductivity stability under heating. Another advantage of this approach is to increase abrasion resistance. One example of thermoplastic polymer is the polyester solution LCC-4 (Flexcon) dissolved in the mixture of acetone and toluene. The thermosetting polymers can be melamine/acrylic copolymers, UV curable epoxy or other systems.

In another preferred embodiment, polymers can be conductive polymers including (but not limited to) polythiophenes, polyanilines and their derivatives with substitution groups. Small amount of conductive polymers are only used to fill the gap space between CNT ropes to have good surface conductivity. Excess amount of these conductive polymer binders will decrease optical transparency of the CNT network coating.

In another preferred embodiment, polymers can be chemically compatible with nanotube and the substrates to display good interfacial bonding and adhesion.

In another preferred embodiment, surface treatment with inorganic-organic hybrid compound forms interfacial bonding or binders. These include silanes, fluorosilane, metal alkoxides, and other related materials.

In the invention, these polymers can be any selection from any preferred embodiment, or any combination of these preferred selections to achieve desired property combination.

The binder coating thickness is preferably in the range of 10-1,000 nm depending on sheet resistance value required. A more preferred rage is 10-500 nm for sheet resistance range of 10-1,000 Ω/□. This binder layer diffuses into the CNT network or mat and provide protection from mechanical damage and moisture infiltration while also exposed some CNT on the surface for conductivity. Coating thickness can be controlled by the binder solution concentration and dip coating conditions such as speed and angles. Properties such as abrasion resistance and moisture resistance depending on coating thickness can be further optimized by these parameters.

2. Coating Layer Structures and Combinations

These preferred polymer binders, for example, can be combined with the nanotube coating in the following coating layer structures:

2.1. Basecoat

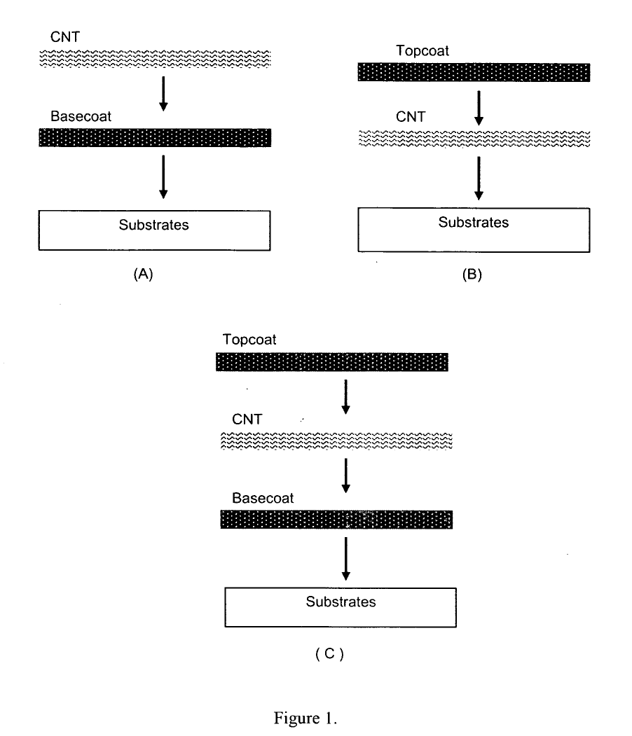

As shown in FIG. 1(A), the selected polymer binder is applied onto the transparent substrates first, following by a layer of carbon nanotube network coating on the top. The nanotube coating can be pressed into thermoplastic or partially cured (“B-staged”) polymer binder layer. The “B-staged” polymer binders can be further cured to form cross-linked structure. Bare carbon nanotubes exposed to the outer surface ensure further electrical connection during service. High degree of penetration of CNT layer into the thermoplastic or “B-staged” thermoset binders is preferred.

2.2. Topcoat

As shown in FIG. 1(B), the selected polymer binder is applied after the CNT conductive coating has been coated onto the substrate. The thermoplastics can be directly applied while thermosetting polymers need to be cured afterwards. This binder layer is expected to diffuse into the CNT network or mat and provide protection from mechanical damage and moisture infiltration while also exposed some CNT on the surface for conductivity.

This coating structure with the topcoat only is preferred due to its better protection than that with the basecoat only.

Combination of Basecoat and Topcoat (“Sandwich Structure”)

By using similar procedures described above, the same or different polymers can be applied as combinations of basecoat and topcoat as shown in FIG. 1(C). Thermoplastics and partially cured (“B-staged”) thermosets are treated the same way as described.

This “sandwich structure” is also preferred for better protection and higher adhesion. In one most preferred embodiment, the basecoat is a partially cured “B-staged” binder followed by formation of CNT network coating. After the CNT network is pressed into the “B-staged” thermoset binder, the binder will be fully cured. The topcoat is formed through subsequent coating with a thermoplastic or thermoset binder. In this way the basecoat is protected from solvents during the late process. The resulting products have good mechanical properties and chemical resistance.

2.4. Combination of Multiple Layers

The combinations of basecoat, topcoat and surface treatment can vary in different layers ranging from single to multiple layers.

3. Process

This invention also provides all the related fabrication methods and processes using the related materials and coating layer structures as described.

4. Methods

This invention also provides all the related methods and resulting products in any form such as coating, film, articles and part of devices.

The resulting products have excellent optical transparency and high electrical conductivity. The conductivity can also be adjusted to in a broad range of sheet resistance. They also offer other advantages including neutral color tone, good adhesion, flexibility, abrasion resistance and environmental resistance (to heat and moisture). Therefore, these products can be used as transparent conductors in display applications.

Basic Evaluation Methods

The examples disclosed herein follows the basic procedures and evaluation methods listed below.

CNT Coating

Carbon nanotubes are coated onto the substrates by spraying purified SWNT inks dispersed in IPA/H₂O (3:1). The substrate is a glass slide (1×3″ in size for testing), or PET film (typically Melinex ST505 in 6×8 cm size for testing). The both ends of the sample are coated with gold by sputtering, or with silver paste as the testing electrodes.

Polymer Binder Coating:

Polymer binders are dissolved in the corresponding solvents to make dilute solutions. The polymer binders are then applied onto the surface by dip coating manually or by automatically using machine. The samples are dried and cured subsequently. In some case (such as B-stage thermoset binder), CNT layer is pressed into the binder layer under a mechanical press with very flat surface (about 4500 psi of pressure for 5-10 minutes) before full curing.

The binders used are listed below
a polyester Lcc-4 dissolved in the mixture of toluene and methyl ethyl ketone (MEK) (available from Flexcon);
a thermal curable melamine/acrylic polymer mixture LCC-5 dissolved in isopropyl alcohol (IPA) (available from Flexcon);
a thermal curable melamine/acrylic polymer mixture LCC-6 dissolved in isopropyl alcohol (IPA) (available from Flexcon) having higher hydrophobicity than LCC-5;
Polyvinylidiene fluoride (PVDF) (Hylar SN from Solvay) dissolved in N,N-dimethyl acetamide;
A nitrocellulose/acylic mixture (“NP resin” in short) diluted in ethyl acetate; A UV curable epoxy UV 15 (from Master Bond) dissolved in methyl ethyl ketone (MEK);
Teflon AF (available from Dupont) dissolved in Fluorinet FC 75 (available from 3M);
SIFEL 611 (a thermal curable fluoropolymer available from Shin-Etsu) dissolved in the solvent X-70580 (available from Shin-Etsu);
An experimental nanosilicate compound is curable under heating through condensation reaction (available from Dupont) diluted in mixture of IPA/water.

Sheet Resistance (Rs) testing

Sheet resistance (Rs in unit of Ω/□) is measured by the well-known two-probe DMM method or four-point probe method.

Humidity Controlled Environments (Moisture Resistance)

Rs value is tested after exposure to different relative humidity (RH %) at the same ambient temperature for about 24 hours. The relative humidity (RH) level in the desiccator with drierite is expected to be zero. Different RH levels are controlled by different saturated solutions in a closed chamber (e.g., KOH, k2CO3, NaCl for RH 9, 43.1, 75.4%, respectively). Each Rs value measured after equilibrium at each RH level is then compared to the value at RH 0% by calculating the change percentage. In most of the situations, the change in stablilized Rs value from the dry state to that at RH 75% is used. Minimum change is preferred.

Thermal Resistance Evaluation

Thermal resistance of the samples in air is evaluated by a quick screening method. This method involves treatment at 125° C. for 2 hours in air following by cooling at the similar ambient conditions for at 16 hours. The change in Rs value compared to the initial Rs value in air is then calculated. Minimum change is preferred.

Abrasion Resistance and Flexibility

The sample surface is abraded by using a weight wrapped with cotton cloth for 60 cycles. Before and after the abrasion test, Rs value is tested and compared. For the sample size in 6×8 cm, a weight of 204 g is used while a weight of 100 g is used for the sample in 1×3″ in size. Minimum change means high abrasion resistance.

For the samples on the polymer films, flexibility is evaluated by a folding test. Mechanical shock with a weight of 4 kg is applied onto the sample to fold the sample inward from the middle. Rs value is then tested and compared to the value before the folding test. Minimum change means high flexibility.

The following comparative and working examples demonstrate the embodiments of the invention, but should not be viewed as limiting the scope of the invention.

### EXAMPLES

### COMPARATIVE EXAMPLES

### CNT/Substrate without Binder

The sample of CNT network coating on glass or PET without any polymer binder is used as the control or benchmark for comparison.

### Comparative Example #CE1

### CNT/Glass

The dispersion of SWNT in 3:1 IPA/water was sprayed onto a cleaned and dried glass slide (1×3″), which had been coated with gold by sputtering at both ends as the electrodes. This sample showed a stable Rs value of 667 Ω/□ after being in the desiccator for 16-24 hrs. The transmittance of the CNT coating at wavelength of 550 nm is 90-91% % (which can be in the range of 92-95% when a better grade of ink is used). This number is used as the baseline value for further comparison. When this sample was exposed to relative humidity level of 9%, the Rs value initially quickly dropped to 580 Ω/□ within 6 minutes and then quickly increased. After being stabilized, the Rs value of 688 Ω/□ was observed. Compared to the baseline in dry (RH0%) condition, the Rs value increased by 3.15% at this relative humidity level (RH9%).

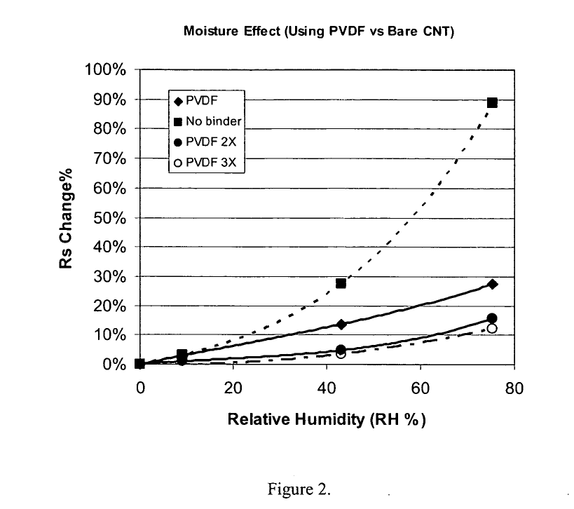

Similarly, the stable Rs values were 850 Ω/□ and 1600 Ω/□, corresponding to exposure to the humidity conditions of RH 43% and 75% for 24 hours, respectively. Compared to the baseline value at dry conditions, these corresponded to an increase by 27.4% and 88.8%, under the two conditions, respectively. The related data are also seen in Table 1 and FIG. 2.

This mean that sheet resistance Rs value of this CNT coating is sensitive to moisture. Rs significantly increases with relative humidity (RH %).

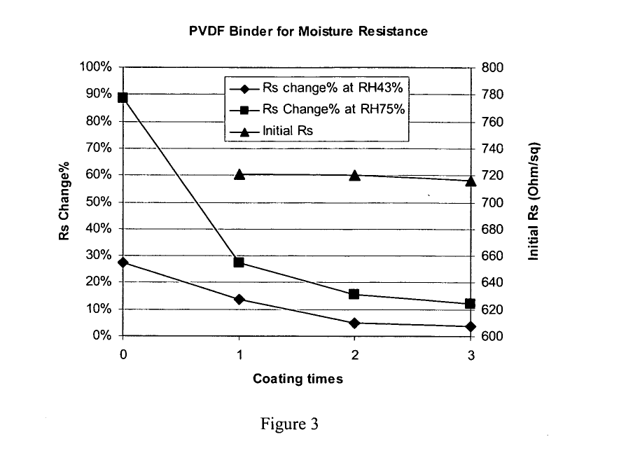

Another identical sample was evaluated for thermal resistance in air. Its initial Rs value in ambient conditions was 664 Ω/□. Rs quickly increased by 150% (to 1659 Ω/□) after 125° C./2 hrs and then decreased and leveled off when exposed to the same ambient conditions again. After cooling for 16 hrs, Rs (1102 Ω/□) was 66% higher than the original. The data can be also seen in Table 1 and FIG. 3.

This means that sheet resistance value of CNT network coating on glass is sensitive to high temperature. Further experiments in dry nitrogen or argon also confirmed the observation. The thermal effect at low temperature ranges (<100° C.) is fully reversible. The change at higher temperatures is only partially reversible.

Another typical sample of CNT/glass was evaluated for adhesion and abrasion resistance. After the sample was peeled using Scotch tape for four times, the Rs value also increased by 4.1 times (Table 1). When the sample was abraded for 60 cycles, its Rs value increased by 336 times (Table 1).

### Comparative Example #CE2

### CNT/PET

The dispersion of SWNT in 3:1 IPA/water was sprayed onto a PET film (Melinex ST 505 from Dupont-Teijin). The sample was then cut into 6×8 cm in size with the both ends pasted with conductive silver paste for further testing. Typical Rs value was in the range of 500-600 Ω/□ while optical transmittance value of this CNT network coating at 550 nm was 89-90% (which can be in the range of 91-94% when a better grade of CNT ink is used).

By the similar screening testing methods, the key results are shown in Table 1.

### Working Examples

### CNT/Substrate with Using Polymer Binders

### Working Example #WE 1

### CNT/Glass with PVDF as the Binder (Topcoat)

By using the same ink used for the comparative examples, the sample of CNT/glass were made. It was then dip-coated with 1% of polyvinylidiene fluoride (PVDF) solution dissolved in N,N-dimethyl acetamide followed by drying, and then tested for moisture resistance in the same way as described. The sample was also coated with PVDF multiple times for better coating quality and higher thickness. The sample was tested each time after coating. The results are shown in FIG. 2, FIG. 3 and Table 2.

Initially the sample showed Rs of 630 Ω/□ at ambient conditions. Stable Rs values of the sample with 1×PVDF coating are 720 and 919 Ω/□, corresponding to RH 0 and 75%, respectively. The change in Rs from the dry state to RH 75% is 27.5%. After twice (2×) coating, stable Rs values are 720 and 833 Ω/□, corresponding to RH 0 and 75%, respectively. The change from the dry state to RH75% is 15.7%. After coating 3×, stable Rs values are 716 and 804 Ω/□, corresponding to RH 0 and 75%, respectively. The change percentage decreases to be 12%. As shown in FIG. 2, the change percentage data are compared to the comparative example (CNT/glass without binder).

PVDF as a type of thermoplastic fluoropolymer improves moisture resistance significantly. With multiple-time coating, moisture resistance is further increased but this improvement tends to level off after 3× coating (FIG. 2 and FIG. 3).

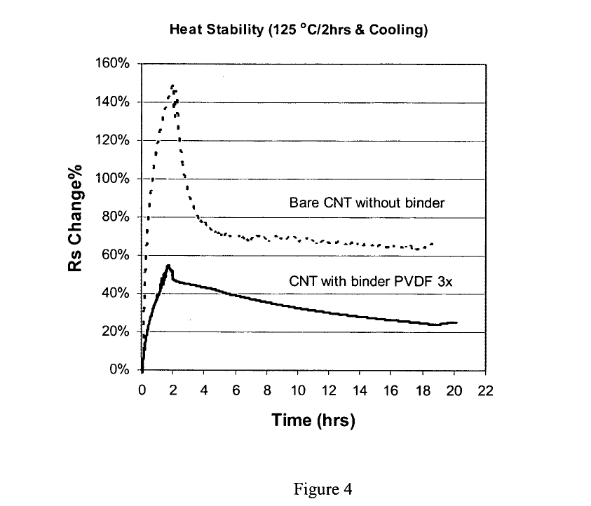

An identical sample of the working example #WE was evaluated for thermal resistance after triple coating with PVDF binder. As shown in FIG. 4, Rs increased by 41% after 125° C./2 hrs. After cooling for 16 hrs, the value was 25% higher than the original. After preheat treatment, this samples showed insignificant change in Rs when tested again at 125° C. Compared to the comparative example (#CE 1), PVDF as binder can significantly increases thermal resistance.

### Working Example #WE 2-5

### CNT/Glass with More Binders (Topcoat)

Other working examples on glass substrate (#WE 2-5) are shown in Table 2 and Table 3. It can be seen that the polymer binders especially the polymer having higher hydrophobicity (e.g., fluoropolymers) give high moisture resistance to the transparent CNT network coating. The thermal resistance can be significantly improved by using polymer binders especially high temperature polymers and cross-linked polymer systems. The abrasion resistance is also significantly improved.

### Working Example #WE 6-7

### CNT/PET with Topcoat Binders

Working example #WE 6-7 in the Table 4 illustrate using polyester and PVDF as top coat binder for the CNT based transparent conductive coating. After binder coating especially after coating for multiple times, all the performance parameters have been improved. Stability of sheet resistance value is further improved by preheating the sample.

### Working Example #WE 8-13

### CNT/PET with different topcoat binders

Working example #WE 8-13 in the Table 5 illustrate using more different polymers including both thermoplastics and thermoset as topcoat binders for the CNT based transparent conductive coating. A sheet of PET (Melinex ST 505, 5 mil, available from Dupont Teijin) was spray-coated with CNT. Its sheet resistance was about 500 Ω/□ while light transmittance was about 89-90% at the wavelength of 550 nm. Different binders were evaluated as topcoat. In addition to polyester and PVDF, these also include Teflon AF (a thermoplastic fluoropolymer from Dupont) dissolved in Fluorinet FC75; SIFEL 611 (a thermal curable fluoropolymer available from Shin-Etsu) dissolved in the solvent X-70580 (available from Shin-Etsu), a nitrocellulose/acylic polymer mixture (“NP resin” in short), and UV curable epoxy UV 15 without oxygen inhibition issue in air (available from Masterbond). Based on the results, selective utilization of polymer binders can result in property improvement including environmental resistance and flexibility.

### Working Example #WE 14-21

### CNT/PET with Topcoat Binders Coated at Different Concentrations

Working example #WE 14-21 in the Table 6 illustrate using polymer binders at different concentration for the CNT based transparent conductive coating. A grade of CNT ink having higher quality (referred as “A-grade” ink) was used. A sheet of PET (Melinex ST 505, 5 mil, available from Dupont Teijin) was spray-coated with CNT. Its sheet resistance was about 500 Ω/□ while light transmittance was about 90-92% at the wavelength of 550 nm. The binders were dip-coated onto the sample manually. The testing results demonstrate the feasibility to adjust the properties by adjusting the binder concentration, in addition to the type of binder selected. Particularly this adjustment needs to correspond to the CNT quality. For example, for this CNT/PET coating made of an A-grade CNT ink, the polyester binder is one of the preferred binder. Its best concentration for this manual coating procedures, 0.13% of concentration is preferred for good balance in different properties.

### Working Example #WE 22-25

### CNT/PET with Polyester Topcoat Binders at Coating Process Conditions

Working example #WE 22-25 in the Table 7 illustrate the feasibility of using coating binder conditions to adjust the properties. A grade of CNT ink having higher quality (referred as “A-grade” ink) was sprayed onto PET (Melinex ST 505, 5 mil, available from Dupont Teijin). Its sheet resistance was about 500 Ω/□ while light transmittance was about 90-92% at the wavelength of 550 nm. The binders were dip-coated onto the sample thorough automatic dip-coating process. The polyester solution at a certain concentration was filled into a tank to immerse the CNT/PET samples for a certain period of time. And then the solution was pumped out at a certain speed.

In Table 7, two set of processing conditions have been tried with slightly different concentrations. For the “quick” process initially tried, polyester solution is filled into a closed tank to immerse CNT/PET samples hanged in the middle. After immersion for 5 minutes, a liquid level is dropped at a rate of 2.5 inches per minute. After all the solutions are pumped out, the film is then pulled out and dried with 100° C. hot air in the entrance of the tank.

For the “slow” process subsequently tried to achieve better transparency, polyester solution is pumped into the tank to immerse the CNT/PET film hanged in the middle. After immersion for 20 minutes, the solution level is dropped at a rate of 0.5 inch per minute. After completely draining the solution, the film is then set in the closed tank for 30 minutes for drying at room temperature. The sample is finally dried at 85° C. in the oven for 10 minutes.

As shown in Table 7, using automatic dip coating at the same concentration of binder solution (0.13%) deliver different results obtained using manual dip coating process. The slow process gives better results at the same concentration. This slow process shows the main advantage in elimination of possible haze during the coating at high RH ambient conditions. 0.35% of polyester solution with the specified slow processing condition is preferred.

The proper selection in binder concentration, solution immersion time, coating speed, drying temperature and time, and other coating parameters can be used to adjust the resulting properties by changing the coating thickness.

### Working Example #WE 26-33

### CNT/PET with Different Coating Layer Structures

Table 8 shows the working examples (#WE 26-33) having different coating layer structure. The topcoat and basecoat compositions are specified. The polyester used is LCC-4 available from Flexcon. The polymer mixture of thermal curable melamine/acrylic is LCC-5 available from Flexcon. All the concentration used is 1%. When thermoplastic polyester was used as the basecoat, CNT coating was pressed under heating and pressure conditions after spray coating. In case of curable materials as the basecoat, the layer is partially cured first to form a “B-stage” perform and then the CNT layer is pressed after spraying coating. Compared to the control, these samples using carbon nanotubes and polymer binders have significant advantages in improved abrasion resistance and flexibility.

Conductive polymers such as polythiophenes and different surface treatments through chemical or physical means are applicable to this invention. Multiple layers of coating structures can be fabricated in different approaches.

A transparent and conductive coating or film comprised of carbon nanotubes and a polymer binder which together form a network, wherein the polymer binder protects the coating or layer by infiltration into the network or functions as secondary conductive layer.

Transparent and conductive coatings or films preferably comprise a transparent substrate which is polymer films including both thermoplastics and thermosets including polyesters, polycarbonates, polyolefins, fluoropolymers, or glass ranging from regular glass to optical display type of glass.

Carbon nanotubes are preferably single walled carbon nanotubes (SWNT) having a desired range of dimension.

Preferred binders are thermoplastics or thermosetting polymers, or any combination of both, including polyesters, polyurethanes, acrylates, epoxies, melamines, silicones, fluoroplastics, fluoroelastomers, and any other copolymer or hybrid polymers via heating, visible light, UV, irradiation or moisture curing or any dual curing mechanisms.

Thermosetting polymers can be partially cured (B-staged) and used as basecoat before nanotube coating during the fabrication and permit the CNT coating and polymer binder coating to have interpenetration into each other.

In one preferred embodiment, polymers are hydrophobic in chemical nature for high moisture resistance, including regular and fluoro-containing thermoplastics, thermosets and elastomers as described herein.

In one preferred embodiment, polymers are thermoplastic having high molecular weight or thermoset with cross-linking structures for high abrasion resistance and thermal resistance.

In one preferred embodiment, preheat treatment of polymer binder/CNT/substrate gives higher heat stability in sheet resistance value.

In one preferred embodiment, polymers can be any conductive polymers including polythiophenes, polyanilines and their derivatives with substitution groups for high surface conductivity.

In one preferred embodiment, polymers can be chemically compatible with nanotube and the substrates to display good interpenetration, interfacial bonding and adhesion.

In one preferred embodiment, surface treatement with inorganic-organic hybrid compound is necessary to form interfacial bonding or binders itself. These include silanes, fluorosilane, metal alkoxides, and other related materials.

These polymers can be any selection or any combination of these preferred selections to achieve desired properties.

The coating layer structures (previously referred as “construction structures”) using nanotube and polymer binders can be in different sequences. One or multiple layers of polymers can be in a single layer only as either basecoat underneath the nanotube coating, or topcoat above the nanotube coating, or any combinations of both.

Polymer binders can be used as the basecoat only in between transparent substrates and cabon nanotube coating. The nanotube coating can be pressed into flexible thermoplastic or partially cured (B-staged) polymer binder layer.

Polymer binders can be used as the topcoat only on the surface of carbon nanotube coating on the transparent substrates.

The same or different polymers can be applied as combinations of basecoat and topcoat to sandwich the carbon nanotube coating, in which thermoplastic or partially cured (B-staged) polymer binders can be used as the basecoat in the process.

Single or multiple layers of binders and conductive layers can be in any combination of these described herein. A carbon nanotube coating is not limited to single layer (not the same meaning of conventional layer, this refers to two coatings interpenetrating to each other).

Binder coating thickness can be adjusted by changing polymer binder concentration during the coating process for desired properties.

Binder coating thickness can be adjusted by changing coating speed during the coating process for desired properties.

Binder coating thickness can be adjusted by changing immersion time, coating angles and other coating processing parameters during the coating process for desired properties.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims.

TABLE 1
Comparative Examples

| | | Comparative Examples (CE) | |
|---|---|---|---|
| | | # CE 1 | # CE 2 |
| Material | No polymer binder | CNT/glass | CNT/PET |
| Moisture | Change in Rs from dry to | 88.8% | 15% |
| Resistance | RH75% after stablilized for | | |
| | 24 hrs | | |
| Thermal | Change in Rs after 125° C./ | 66% | 23% |
| Resistance | 2 hrs and then room | | |
| | temperature for 16 hrs) | | |
| Adhesion | Change in Rs after peeling | 4100% | 0.9% |
| | using scotch tape for 4 times | | |
| Abrasion | Change in Rs after abrasion | 33600% | 1830% |
| Resistance | for 60 cycles | | |
| Flexibility | Change in Rs after the | — | 9% |
| | folding test | | |

TABLE 2

| | | Working Examples (CE) | | | |
|---|---|---|---|---|---|
| | | # WE 1 | # WE 2 | # WE 3 | # WE 4 |
| Material | Substrate | CNT/glass | CNT/glass | CNT/glass | CNT/glass |
| | Polymer binder | 1% | 1% | 1% | 1% |
| | | PVDF | polyester | Melamine/acrylic | Melamine/acrylic |
| | | | (LCC-4) | (LCC-5) | (LCC-6) - more |
| | | | | | hydrophobic |
| Sheet Resistance | Before binder coating | 630 | 826 | 790 | 676 |
| (Rs, Ω/□) | After coating 1x | 721 | 858 | 979 | 883 |
| Moisture | Change in Rs from dry to | 27.5% | 22.4% | 37.0% | 21.7% |
| Resistance | RH75% after stablilized | | | | |
| | for 24 hrs | | | | |
| Sheet Resistance | After coating 3x | 716 | 983 | 1246 | 1117 |
| (Rs, Ω/□) | | | | | |
| Moisture | Change in Rs from dry to | 12.3% | 7.0% | 26.4% | 16.9% |
| Resistance | RH75% after stablilized | | | | |
| | for 24 hrs | | | | |
| Thermal | Change in Rs after 125° C./ | 25% | 33% | 11% | 9% |
| Resistance | 2 hrs and then room | | | | |
| | temperature for 16 hrs) | | | | |

TABLE 3

| | | Examples | | |
|---|---|---|---|---|
| | | # CE 1 | # WE 5 | # WE 2 |
| Material | Substrate | CNT/glass | CNT/glass | CNT/glass |
| | Polymer binder | none | 0.125% | 1% polyester |
| | | | polyester | (LCC-4) |
| | | | (LCC-4) | |
| Adhesion | Change in Rs after | 4100% | 0.1% | 0.0% |
| | peeling using | | | |
| | scotch tape for 4 | | | |
| | times | | | |
| Abrasion | Change in Rs after | 33600% | 143% | 12% |
| Resistance | abrasion for 60 | | | |
| | cycles | | | |

TABLE 4

| | | Working Examples | |
|---|---|---|---|
| | | (CE) | |
| | | # WE 6 | # WE 7 |
| Material | Substrate | CNT/PET | CNT/PET |
| | Polymer binder | 1% | 1% PVDF |
| | | polyester | (Haylar |
| | | (LCC-4) | SN) |
| Sheet | Before binder coating | 525 | 474 |
| Resistance | After binder coating 1x | 636 | 612 |
| (Rs, Ω/□) | After binder coating 3x | 755 | 694 |
| Moisture | Change in Rs from dry to RH75% | 2.0% | 6.1% |
| Resistance | after stablilized for 24 hrs | | |
| Thermal | Change in Rs after 125° C./2 hrs and | 31% | 23% |
| Resistance | then room temperature for 16 hrs) | | |
| Sheet | After preheatment (125 C/2 hrs & | 1057 | 905 |
| Resistance | cooling) | | |
| (Rs, Ω/□) | | | |
| Moisture | Change in Rs from dry to RH75% | 0.5% | 4.9% |
| Resistance | after stablilized for 24 hrs | | |
| Thermal | Change in Rs after 125° C./2 hrs and | 6% | 3% |
| Resistance | then room temperature for 16 hrs) | | |
| Abrasion | Change in Rs after abrasion for 60 | 52% | 133% |
| Resistance | cycles (weight 204 g for 6 × 8 cm | | |
| | size) | | |
| Flexibility | Change in Rs after the folding test | 7% | 4% |

TABLE 5

| | | Working Examples (CE) | | | | | |
|---|---|---|---|---|---|---|---|
| | | # WE 8 | # WE 9 | # WE 10 | # WE 11 | # WE 12 | # WE 13 |
| Material | Substrate | CNT/PET | CNT/PET | CNT/PET | CNT/PET | CNT/PET | CNT/PET |
| | Polymer binder | NP resin | Teflon AF | PVDF | Polyester | UV curable | SIFEL 611 |
| | | | | (Hylar | (Lcc-4) | Epoxy | |
| | | | | SN) | | (UV15) | |
| | Binder concentration | 0.13% | 1% | 1% | 1% | 1% | 1% |
| Conductivity | Change in Rs upon | 8% | 11% | 32% | 36% | 93% | 16% |
| | coating | | | | | | |
| Moisture | Change in Rs from dry | 19% | 8% | 8% | 5% | 14% | 11% |
| Resistance | to RH75% after | | | | | | |
| | stablilized for 24 hrs | | | | | | |
| Thermal | Change in Rs after 125° C./ | 22% | 18% | 10% | 13% | −5% | 9% |
| Resistance | 2 hrs and then room | | | | | | |
| | temperature for 16 hrs) | | | | | | |
| Abrasion | Change in Rs after | 2513% | 9% | 91% | 98% | 700% | 1364% |
| Resistance | abrasion for 60 cycles | | | | | | |
| | (weight 204 g for 6 × 8 cm | | | | | | |
| | size) | | | | | | |
| Flexibility | Change in Rs after the | 10% | 6% | 3% | 5% | 5% | 0% |
| | folding test | | | | | | |

TABLE 6

| | | Examples | | | | | | | | |
|---|---|---|---|---|---|---|---|---|---|---|
| | | # CE 3 | | | | | | | | |
| | | (comparative | # WE | # WE | # WE | | | | | |
| | | example) | 14 | 15 | 16 | # WE 17 | # WE 18 | # WE 19 | # WE 20 | # WE 21 |
| Material | Substrate | CNT/PET | CNT/ | CNT/ | CNT/ | CNT/PET | CNT/PET | CNT/PET | CNT/PET | CNT/PET |
| | Polymer binder | — | PET | PET | PET | NP resin | NP resin | Nanosilicate | Nanosilicate | Nanosilicate |
| | | | Poly- | Poly- | Poly- | | | | | |
| | | | ester | ester | ester | | | | | |
| | Binder concentration | — | 0.13% | 0.50% | 1.00% | 0.13% | 0.50% | 0.13% | 0.25% | 0.50% |
| Conductivity | Change in Rs upon | — | 27% | 70% | 99% | 10% | 12% | 43% | 57% | 95% |
| | coating | | | | | | | | | |
| Moisture | Change in Rs from dry | 14% | 7.0% | 6.7% | 6.6% | 12% | 12% | 11% | 17% | 15% |
| Resistance | to RH75% after | | | | | | | | | |
| | stablilized for 24 hrs | | | | | | | | | |
| Thermal | Change in Rs after | 40% | 30% | 20% | 62% | 47% | 36% | 30% | 35% | 27% |
| Resistance | 125° C./2 hrs and then | | | | | | | | | |
| | room temperature for 16 | | | | | | | | | |
| | hrs) | | | | | | | | | |
| Abrasion | Change in Rs after | 2993% | 231% | 105% | 84% | 1586% | 459% | 482% | 168% | 142% |
| Resistance | abrasion for 60 cycles | | | | | | | | | |
| | (weight 204 g for 6 × 8 | | | | | | | | | |
| | cm size) | | | | | | | | | |
| Flexibility | Change in Rs after the | 4% | 5% | 5% | 6% | 6% | 8% | 5% | 5% | 3% |
| | folding test | | | | | | | | | |

TABLE 7

| | | Examples | | | | |
|---|---|---|---|---|---|---|
| | | # WE 14 | # WE 22 | # WE 23 | # WE 24 | # WE 25 |
| Material | Substrate | CNT/PET | CNT/PET | CNT/PET | CNT/PET | CNT/PET |
| | Polymer binder | Polyester | Polyester | Polyester | Polyester | Polyester |
| | Binder concentration | 0.13% | 0.13% | 0.25% | 0.25% | 0.35% |
| | Coating process | Manual Dip- | Automatic Dip-coating | | Automatic Dip-coating | |
| | | coating | (quick speed) | | (slow speed) | |
| Conductivity | Change in Rs upon | 27% | 4% | 8% | 11% | 20% |
| | coating | | | | | |
| Moisture | Change in Rs from dry | 7.0% | 15.0% | — | 10% | 5% |
| Resistance | to RH75% after | | | | | |
| | stablilized for 24 hrs | | | | | |
| Thermal | Change in Rs after 125° C./ | 30% | 38% | 12% | 12% | 2% |
| Resistance | 2 hrs and then room | | | | | |
| | temperature for 16 hrs) | | | | | |
| Abrasion | Change in Rs after | 231% | 1059% | 973% | 373% | 137% |
| Resistance | abrasion for 60 cycles | | | | | |
| | (weight 204 g for 6 × 8 cm | | | | | |
| | size) | | | | | |
| Flexibility | Change in Rs after the | 5% | 4% | 3% | 1% | 3% |
| | folding test | | | | | |

TABLE 8

| | | Examples | | | | | | | |
|---|---|---|---|---|---|---|---|---|---|
| | | # WE 26 | # WE 27 | # WE 28 | # WE 29 | # WE 30 | # WE 31 | # WE 32 | # WE 33 |
| Material | Substrate | CNT/PET | CNT/PET | CNT/PET | CNT/PET | CNT/PET | CNT/PET | CNT/PET | CNT/PET |
| | Basecoat binder | — | Polyester | Polyester | Polyester | — | Melamine/ | Melamine/ | Melamine/ |
| | | | | | | | acrylic | acrylic | acrylic |
| | Topcoat binder | Polyester | — | Polyester | Melamine/ | Melamine/ | — | Polyester | Melamine/ |
| | | | | | acrylic | acrylic | | | acrylic |
| | Binder concentration | 0.5% | 0.5% | 0.5% | 0.5% | 0.5% | 0.5% | 0.5% | 0.5% |
| Abrasion | Change in Rs after | 370% | 39858% | 67% | 130% | 123% | 476% | 38% | 96% |
| Resistance | abrasion for 60 cycles | | | | | | | | |
| | (weight 204 g for 6 × 8 cm | | | | | | | | |
| | size) | | | | | | | | |
| Flexibility | Change in Rs after the | 1% | 6% | 4% | 2% | 2% | 5% | 2% | 3% |
| | folding test | | | | | | | | |

1. A transparent and conductive coating or film comprised of carbon nanotubes and a polymer binder which together form a network, wherein the polymer binder protects the coating or layer by infiltration into the network.

2. The coating or film of claim 1, wherein the carbon nanotubes are SWCNT.
